(19) United States
(12) Patent Application Publication
(10) Pub. No.: US 2026/0138642 A1
(43) Pub. Date: May 21, 2026

(54) METHOD AND APPARATUS WITH VEHICLE PATH GENERATION

(71) Applicants: Samsung Electronics Co., Ltd., Suwon-si (KR); Korea Advanced Institute of Science and Technology, Daejeon (KR)

(72) Inventors: Jawook Huh, Suwon-si (KR); Jeonghwan KIM, Daejeon (KR); Jiongdao JIN, Daejeon (KR); Sungju HWANG, Daejeon (KR); Jaewook YOO, Suwon-si (KR); Jaehong YOON, Chapel Hill, NC (US); Dongwook LEE, Suwon-si (KR)

(73) Assignees: Samsung Electronics Co., Ltd., Suwon-si (KR); Korea Advanced Institute of Science and Technology, Daejeon (KR)

(21) Appl. No.: 19/388,742

(22) Filed: Nov. 13, 2025

Related U.S. Application Data
(60) Provisional application No. 63/721,065, filed on Nov. 15, 2024.

(30) Foreign Application Priority Data
Jan. 9, 2025 (KR) 10-2025-0003359

(51) Int. Cl. B60W 60/00; B60W 50/00

(52) U.S. Cl. CPC B60W 60/0011; B60W 50/0097; B60W 60/0015; B60W 2552/53; B60W 2554/4041; B60W 2554/4044; B60W 2554/4045; B60W 2554/80; B60W 2556/10

(57) ABSTRACT

A processor-implemented method including generating a plurality of candidate paths available for a vehicle to select, predicting, based on sensing data on surroundings of the vehicle, a next action of each of a plurality of other vehicles located around the vehicle, predicting, based on the next action and the plurality of candidate paths, a next state corresponding to each of the plurality of candidate paths, and determining, based on the next state, a driving path of the vehicle.

### CROSS-REFERENCE TO RELATED APPLICATIONS

This application claims the benefit under 35 U.S.C. § 119 (e) of U.S. Provisional Application No. 63/721,065 filed on Nov. 15, 2024, in the U.S. Patent and Trademark Office, and claims the benefit under 35 USC § 119 (a) of Korean Patent Application No. 10-2025-0003359 filed on Jan. 9, 2025, in the Korean Intellectual Property Office, the entire disclosures of which are incorporated herein by reference for all purposes.

### BACKGROUND

### 1. Field

The following description relates to a method and apparatus with vehicle path generation.

### 2. Description of Related Art

One of the main challenges in autonomous driving (AD) technology is planning and executing safe driving paths. To address this, an AD system may be required to accurately predict the paths of other vehicles around an ego-vehicle and use these predictions to safely plan the path of the ego-vehicle. Training data used for path prediction in an AD system is typically collected from real-world scenarios. However, such data rarely includes abnormal driving scenarios, such as vehicle collisions, wrong-way driving, or off-road incidents. Consequently, in reality, the robustness of path prediction may decrease when a vehicle faces a dangerous situation. Moreover, collecting data on abnormal or hazardous driving scenarios is extremely difficult and often requires significant costs.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including generating a plurality of candidate paths available for a vehicle to select, predicting, based on sensing data on surroundings of the vehicle, a next action of each of a plurality of other vehicles located around the vehicle, predicting, based on the next action and the plurality of candidate paths, a next state corresponding to each of the plurality of candidate paths, and determining, based on the next state, a driving path of the vehicle.

The sensing data may include lane data obtained by sensing a lane located around the vehicle and driving data obtained by sensing driving information for each of the plurality of other vehicles.

The predicting of the next action may include obtaining an interaction result between the lane data and the driving data for each of the plurality of other vehicles and predicting, based on the interaction result, the next action of each of the plurality of other vehicles.

The driving data for each of the plurality of other vehicles may include information on a driving history, a velocity, an acceleration, a direction, and a location of each of the plurality of other vehicles.

The plurality of candidate paths may be generated based on an available range of steering and an available range of velocity of the vehicle.

The next state may include a probability value assigned based on a likelihood of the vehicle driving in each of the plurality of candidate paths.

The likelihood of the vehicle driving in each of the plurality of candidate paths is calculated based on one or more of a distance loss function related to a distance between the vehicle and the plurality of other vehicles and a departure loss function related to roadway departure of the vehicle.

The next state may be obtained based on a result of performing cross attention between the plurality of candidate paths and the next action of each of the plurality of other vehicles.

The next state may include a predicted location of the vehicle after the vehicle drives for a predetermined time along each of the plurality of candidate paths and respective locations of each of the plurality of other vehicles after the predetermined time elapses.

In a general aspect, here is provided a non-transitory computer-readable storage medium storing instructions that, when executed by a processor, cause the processor to perform the method.

In a general aspect, here is provided an electronic apparatus including processors configured to execute instructions, a memory storing the instructions, and an execution of the instructions configures the processors to generate a plurality of candidate paths available for a vehicle to select, predict, based on sensing data on surroundings of the vehicle, a next action of each of a plurality of other vehicles located around the vehicle, predict, based on the next action and the plurality of candidate paths, a next state corresponding to each of the plurality of candidate paths, and determine, based on the next state, a driving path of the vehicle.

The sensing data may include lane data obtained by sensing a lane located around the vehicle and driving data obtained by sensing driving information for each of the plurality of other vehicles.

The predicting of the next action may include obtaining an interaction result between the lane data and the driving data for each of the plurality of other vehicles and predicting, based on the interaction result, a next action of each of the plurality of other vehicles.

The driving data for each of the plurality of other vehicles may include information on a driving history, a velocity, an acceleration, a direction, and a location of each of the plurality of other vehicles.

The plurality of candidate paths may be generated based on an available range of steering and an available range of velocity of the vehicle.

The next state corresponding to each of the plurality of candidate paths may include a probability value assigned based on a likelihood of the vehicle driving in each of the plurality of candidate paths.

The likelihood of the vehicle driving in each of the plurality of candidate paths may be calculated based on one or more of a distance loss function related to a distance between the vehicle and the plurality of other vehicles and a departure loss function related to roadway departure of the vehicle.

The next state may be obtained based on a result of performing cross attention between the plurality of candidate paths and a next action of each of the plurality of other vehicles.

The next state may include a predicted location of the vehicle after the vehicle drives for a predetermined time along each of the plurality of candidate paths and respective locations of each of the plurality of other vehicles after the predetermined time elapses.

Other features and aspects will be apparent from the following detailed description, the drawings, and the claims.

### BRIEF DESCRIPTION OF THE DRAWINGS

FIG. 1 illustrates an example autonomous driving (AD) system according to one or more embodiments.

FIG. 2 illustrates an example method of generating a path for an AD according to one or more embodiments.

FIG. 3 illustrates an example path generating device according to one or more embodiments.

FIG. 4 illustrates an example method of generating a driving path according to one or more embodiments.

FIG. 5 illustrates an example world model according to one or more embodiments.

FIG. 6 illustrates an example predicted trajectory according to one or more embodiments.

FIG. 7 illustrates an example predicted next state according to one or more embodiments.

FIG. 8 illustrates an example decoder according to one or more embodiments.

FIG. 9 illustrates an example method of generating a path according to one or more embodiments.

FIG. 10 illustrates an example electronic apparatus according to one or more embodiments.

Throughout the drawings and the detailed description, unless otherwise described or provided, it may be understood that the same drawing reference numerals refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when a component or element is described as being “on”, “connected to,” “coupled to,” or “joined to” another component, element, or layer it may be directly (e.g., in contact with the other component or element) “on”, “connected to,” “coupled to,” or “joined to” the other component, element, or layer or there may reasonably be one or more other components, elements, layers intervening therebetween. When a component or element is described as being “directly on”, “directly connected to,” “directly coupled to,” or “directly joined” to another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

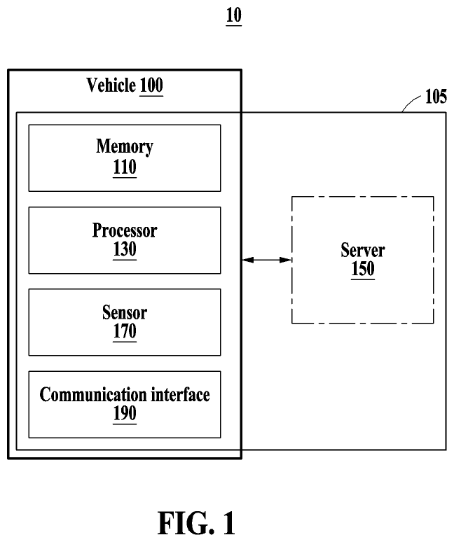

FIG. 1 illustrates an example autonomous driving (AD) system according to one or more embodiments.

Referring to FIG. 1, in a non-limiting example, an AD system (e.g., a system 10) may be a system that generates a driving path and controls the driving of a vehicle 100 based on sensing data on the surroundings of a vehicle (e.g., the vehicle 100). An AD device 105 may be mounted inside the vehicle 100 and control the driving of the vehicle 100. For example, the AD device 105 may be software stored in a memory 110 of the vehicle 100 and implemented on a processor 130 of the vehicle 100. In an example, some of the components of the AD device 105 may be located outside of the vehicle 100, such as server 105. In addition, while some elements are illustrated as being within AD device 105, some elements may be instead part of the vehicle 100 or external to the vehicle 100. For example, instructions to generate a path of the AD device 105 of the vehicle 100 may be implemented on the server 150, and the server 150 may transmit a generated driving path to the vehicle 100. The vehicle 100 may be a vehicle that transports people and/or articles and may include a vehicle such as a car. The vehicle 100 may be an AD vehicle.

The AD device 105 may obtain, from a sensor 170, sensing data on the surroundings of the vehicle 100. The sensing data may include data obtained by sensing a lane located around the vehicle 100 and data obtained by sensing driving information on each of a plurality of other vehicles. The sensing data may further include data obtained by sensing dynamic objects (e.g., dynamic objects such as pedestrians and two-wheelers) located around the vehicle 100. The driving information on each of the plurality of other vehicles may include information on the driving history, velocity, acceleration, direction, and location of each of the plurality of other vehicles. The sensor 170 may be mounted on the vehicle 100 and may sense a surrounding environment. That is, while the sensor 170 is shown in an example as being within AD device 105 in FIG. 1, the sensor 170 may be, in another example, provided solely within the vehicle 100 while communicating with the AD device to provide the data (i.e., sensing driving information on each of a plurality of other vehicles). The sensor 170 may be used to collect data on a surrounding environment such as information (e.g., information on a road such as a lane, a traffic sign, and an obstacle) on a road surrounding the vehicle 100 and other vehicles. The sensor 170 may include a plurality of sensors. For example, the sensor 170 may include a plurality of sensors such as a light detection and ranging (LiDAR) sensor, a radar sensor, an image sensor, an event sensor, an illuminance sensor, a global positioning system (GPS) device, and an acceleration sensor.

In an example, the server 150 may be a central server that collects data from a plurality of vehicles including the vehicle 100 and processes and analyzes the data in real time. For example, the server 150 may provide the latest map to a vehicle (e.g., the vehicle 100) or update software installed on the vehicle 100 through over the air (OTA) update.

In an example, a communication interface 190 may support communication between the vehicle 100 and an external device (e.g., the server 150). The communication interface 190 may include a wireless communication device such as a cellular communication device, a short-range communication device, or a global navigation satellite system (GNSS) communication device. The vehicle 100 may transmit the sensing data to the server 150 using the communication interface 190 and receive information (e.g., the latest map data and a driving path) from the server 150.

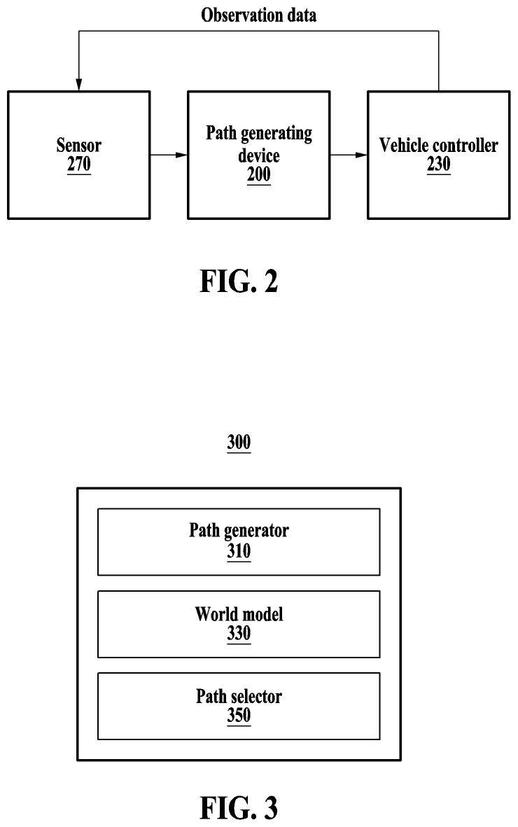

FIG. 2 illustrates an example method of generating a path for an AD according to one or more embodiments.

Referring to FIG. 2, in a non-limiting example, a path generating device 200 may receive, from a sensor 270 (e.g., the sensor 170 of FIG. 1), sensing data on the surroundings of an ego-vehicle (e.g., the vehicle 100 of FIG. 1), generate a driving path of the vehicle 100, and transmit the driving path to a vehicle controller 230. The path generating device 200 may be a component of the AD device 105 described with reference to FIG. 1. The path generating device 200 may be implemented inside the vehicle 100 or implemented outside (e.g., the server 150 of FIG. 1) the vehicle 100.

The path generating device 200 may recognize the surroundings of the vehicle 100 based on the data (e.g., the sensing data) received from the sensor 270. For example, the path generating device 200 may use the sensing data to build a model (e.g., a world model 330 of FIG. 3) for a surrounding environment of the vehicle 100 and recognize and classify objects (e.g., objects such as other vehicles, pedestrians, and traffic signs). The path generating device 200 may predict a next action of a dynamic object based on information obtained by analyzing the surroundings of the vehicle 100. For example, the path generating device 200 may predict next actions of a plurality of other vehicles located around the vehicle 100. The path generating device 200 may use time-series analysis and a world model to predict the next action of the dynamic object (e.g., a dynamic object such as other vehicles, pedestrians, and two-wheelers) located around the vehicle 100. For example, the path generating device 200 may predict future locations and/or behaviors of all dynamic objects (e.g., dynamic objects such as other vehicles, pedestrians, and two-wheelers) located around the vehicle 100.

The path generating device 200 may generate a plurality of candidate paths that are available for the vehicle 100 to select. The path generating device 200 may generate the plurality of candidate paths based on an available range of steering and an available range of velocity. For example, the path generating device 200 may generate the plurality of candidate paths available for the vehicle 100 to select according to a combination of a steering angle within an available range of steering and a velocity within an available range of velocity of the vehicle 100.

In an example, a driving path of the vehicle 100 generated by the path generating device 200 may be used to train a world model (e.g., the world model 330 of FIG. 3). The path generating device 200 may perform a simulation of an abnormal driving situation by using, as training data, every path in which the vehicle 100 may drive in addition to actual driving data and data obtained by augmenting (e.g., transforming and augmenting such as rotating an angle) the actual driving data. For example, the path generating device 200 may perform simulations of various driving situations such as a situation in which the vehicle 100 leaves a roadway, collides with another vehicle, or drives the wrong way and calculate a loss of each driving situation, thereby generating a much safer driving path.

The path generating device 200 may predict, based on the next action of each of the other vehicles located around the vehicle 100 and the plurality of candidate paths available for the vehicle 100 to select, a next state corresponding to each of the plurality of candidate paths. For example, the path generating device 200 may predict a situation expected to occur when the vehicle 100 selects each path candidate and drives. The path generating device 200 may predict a next state corresponding to each path candidate by simulating a driving situation for each of the plurality of candidate paths available for the vehicle 100 to select. The path generating device 200 may determine the driving path of the vehicle 100 based on the predicted next state. The path generating device 200 may determine a driving path in which the vehicle 100 may drive to a destination in the safest and most efficient way. The path generating device 200 may transmit the determined driving path to the vehicle controller 230. The vehicle controller 230 may control the movement of the vehicle 100. The sensor 270 may continuously sense the surrounding situation of the vehicle 100 after the movement of the vehicle 100 is controlled by the vehicle controller 230 and transmit the sensed situation to the path generating device 200. The path generating device 200 may generate the driving path of the vehicle 100 by considering the surrounding situation of the vehicle 100 in real time.

The path generating device 200 may use a world model (e.g., the world model 330 of FIG. 3) to predict the next actions of vehicles other than the ego-vehicle (e.g., the vehicle 100) and generate a safe driving path that prevents collisions between the vehicle 100 and other vehicles. The path generating device 200 may determine the safest and most efficient driving path for the vehicle 100 based on at least one of a loss function related to the distance between the vehicle 100 and the plurality of other vehicles and a loss function related to the vehicle 100 deviating from the road.

Each component (e.g., the sensor 270, the path generating device 200, and the vehicle controller 230) may communicate with each other via a network (not shown). For example, the network may include a local area network (LAN), a wide area network (WAN), a value added network (VAN), a mobile radio communication network, a satellite communication network, and a combination thereof. The network may be a comprehensive data communication network that enables seamless communication between the components (e.g., the sensor 270, the path generating device 200, and the vehicle controller 230) and may include wired internet, wireless internet, and a mobile wireless communication network. Additionally, the wireless communication network may include, for example, wireless LAN (wireless fidelity (Wi-Fi)), Bluetooth, Bluetooth low energy (BLE), Zigbee, Wi-Fi Direct (WFD), ultra-wideband (UWB), infrared data association (IrDA), and near field communication (NFC), but examples are not limited thereto.

FIG. 3 illustrates an example path generating device according to one or more embodiments.

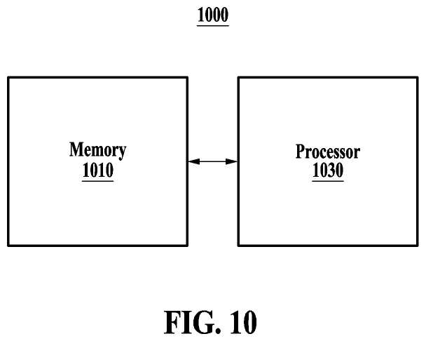

Referring to FIG. 3, in a non-limiting example, a path generating device 300 (e.g., the path generating device 200 of FIG. 2) may include a path generator 310, the world model 330, and a path selector 350. The path generator 310, the world model 330, and the path selector 350 may be software implemented on a processor (e.g., a processor 1030 of FIG. 10) of the path generating device 300. The path generator 310, the world model 330, and the path selector 350 are illustrated as an example to describe the path generating device 300 and may include various modifications as long as the operations of the path generating device 300 described in this disclosure may be implemented. For example, two or more components may be combined, or one or more components may be added or omitted.

The path generating device 300 may receive sensing data related to the surroundings of the vehicle 100. For example, the path generating device 300 may receive, from a sensor (e.g., the sensor 170 of FIG. 1) mounted on the vehicle 100, data obtained by sensing a lane located around the vehicle 100 and data obtained by sensing driving information on each of a plurality of other vehicles located around the vehicle 100. The sensing data may further include data obtained by sensing dynamic objects (e.g., dynamic objects such as pedestrians and two-wheelers) located around the vehicle 100. The path generating device 300 may receive the destination of the vehicle 100. For example, the path generating device 300 may receive the destination of the vehicle 100 from a user input and use the destination for generating a path. Using the path generator 310, the path generating device 300 may generate a plurality of candidate paths in which the vehicle 100 may drive and perform a simulation of a driving situation through the world model 330. The path generating device 300 may use the path selector 350 to determine the safest and most efficient path, enabling the vehicle 100 to perform safe AD.

The world model 330 may be a model that functions as a simulator that predicts how the driving environment is affected based on the plurality of candidate paths that the vehicle 100 may select. The path generating device 300, through the world model 330, may predict in advance how an action (e.g., control of acceleration, deceleration, and steering) of the vehicle 100 impacts a driving environment and determine the action (e.g., control of acceleration, deceleration, and steering) of the vehicle 100 to enable safe AD of the vehicle 100. A next state that the world model 330 may predict may include not only a situation predicted according to actual driving data but also all possible situations that may occur during driving, such as collisions between the vehicle 100 and other vehicles or the vehicle 100 departing from the road. The world model 330 may compare the predicted next state with ground truth (GT) data (e.g., actual driving data) to assign a reward and may perform, based on the reward, reinforcement learning. By repeating the learning process and predicting the next state of the vehicle 100 in real time, the world model 330 may enable the vehicle 100 to drive more safely and efficiently.

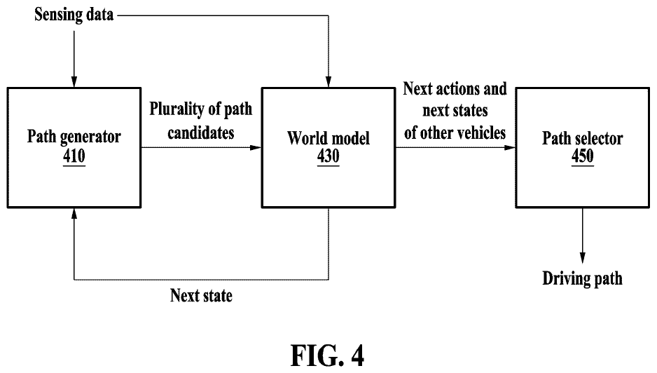

The path generator 310, the world model 330, and the path selector 350 may be updated via a communication interface (e.g., the communication interface 190 of FIG. 1) after training is performed outside (e.g., the server 150 of FIG. 1) the vehicle 100. The particular operations of each component (e.g., the path generator 310, the world model 330, and the path selector 350) of the path generating device 300 are described in detail below with reference to FIG. 4.

FIG. 4 illustrates an example method of generating a driving path according to one or more embodiments.

Referring to FIG. 4, in a non-limiting example, a path generator 410 (e.g., the path generator 310 of FIG. 3), a world model 430 (e.g., the world model 330 of FIG. 3), and a path selector 450 (e.g., the path selector 350 of FIG. 3) may be integrated via a network. Data transmitted and received between the path generator 410, the world model 430, and the path selector 450 may be in either a compressed or raw form. The path generator 410, the world model 430, and the path selector 450 are illustrated as an example to describe the path generating device 300 described with reference to FIGS. 1 through 3 and may include various modifications. For example, two or more components may be combined, or one or more components may be added or omitted.

In an example, the path generator 410 may generate a plurality of candidate paths that an ego-vehicle (e.g., the vehicle 100 of FIG. 1) may select. The path generator 410 may receive sensing data related to the surroundings of the vehicle 100 and generate the plurality of candidate paths that the vehicle 100 may select. The path generator 410 may be an artificial intelligence (AI) model. The path generator 410 may generate the plurality of candidate paths based on an available range of steering and an available range of velocity of the vehicle 100. For example, the path generator 410 may generate the plurality of candidate paths that the vehicle 100 may select based on a combination of steering (e.g., straight, left turn, and right turn) within the available range of steering and velocity (e.g., acceleration and deceleration) within the available range of velocity of the vehicle 100. The path generator 410 may further consider the destination of the vehicle 100 when generating the plurality of candidate paths. For example, the path generator 410 may generate the plurality of candidate paths that the vehicle 100 may select based on the received destination of the vehicle 100. The plurality of candidate paths is a combination of motions that the vehicle 100 may select and may be generated as either compressed data or raw data. The path generator 410 may transmit the generated plurality of candidate paths to the world model 430.

The world model 430 may be a model that serves as a simulator that predicts the impact on a driving environment based on the plurality of candidate paths that the ego-vehicle (e.g., vehicle 100) may select. The world model 430 may be an AI model. Based on the surroundings and the action (e.g., control of acceleration, deceleration, and steering) of the vehicle 100, the world model 430 may predict a next state. The surroundings of the vehicle 100 may include a lane located around the vehicle 100, a dynamic object (e.g., a dynamic object such as a plurality of other vehicles, pedestrians, and two-wheelers), and a signal status. Based on sensing data related to the surroundings of the vehicle 100, the world model 430 may predict the next actions of each of the plurality of other vehicles located around the vehicle 100. The sensing data may include data obtained by sensing a lane located in proximity to the vehicle 100 and data obtained by sensing driving information for each of the plurality of other vehicles. The world model 430 may predict the next action of each of the plurality of other vehicles based on information on the driving history, velocity, acceleration, direction, and location of each of the plurality of other vehicles. For example, the world model 430 may predict the future position and/or action of each of the plurality of other vehicles located around the vehicle 100 based on driving information (e.g., driving history, velocity, acceleration, direction, and location) of each of the plurality of other vehicles.

The world model 430 may predict a next state corresponding to each of the plurality of candidate paths, based on the next action of each of the plurality of other vehicles and the candidate paths that the vehicle 100 may select. The next state may include a probability value assigned based on the likelihood of the vehicle 100 driving in each of the plurality of candidate paths. The next state may include the predicted location of the vehicle 100 after the vehicle 100 drives along each of the plurality of candidate paths for a predetermined time (e.g., a prediction time) and the positions of the plurality of other vehicles after a predetermined time elapses. For example, the world model 430 may predict the position and signal status of each of the plurality of other vehicles at a prediction point in time and the next state that may occur in relation to other vehicles based on the action (e.g., a selected path) of the vehicle 100. The world model 430 may assign a reward by comparing the predicted next state with GT data (e.g., actual driving data) and perform reinforcement learning based on the reward. For example, the world model 430 may calculate a loss for the predicted next state using Equation 1 below.

$$loss = {\sum }_{i} ( {reward}_{i}^{pred} - {reward}_{i}^{gt} ) \qquad Equation 1$$

The range of values calculated according to Equation 1 may be defined as needed. The world model 430 may be trained in a direction in which the loss value between the GT data (e.g., actual driving data) and the predicted next state decreases. By repeating the learning process and predicting the next state of the vehicle 100 in real time, the world model 430 may enable the vehicle 100 to drive more safely and efficiently.

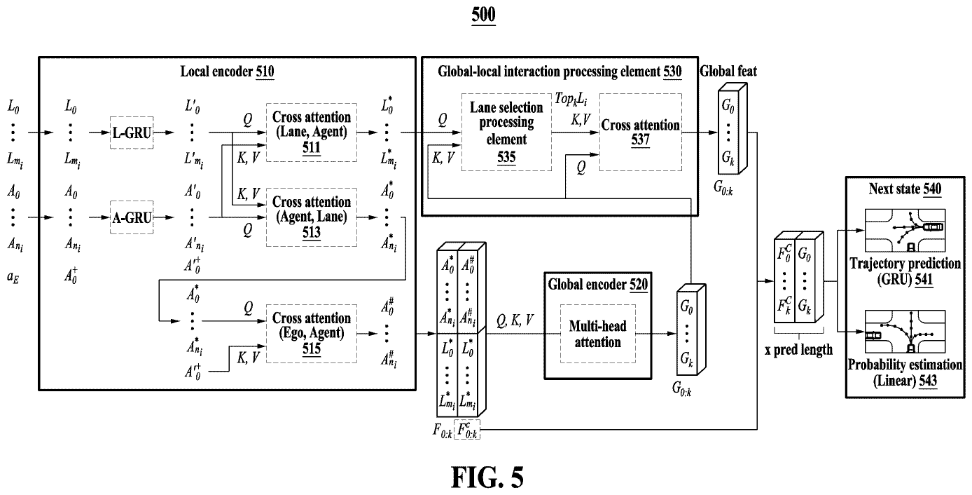

An operation in which the world model 430 predicts the next action of each of the plurality of other vehicles and predicts the next state corresponding to each of the plurality of candidate paths of the vehicle 100 is described in greater detail below with reference to FIG. 5. The world model 430 may transmit the next state to the path generator 410. The path generator 410 may receive the next state from the world model 430 and generate a path of the vehicle 100 at the next point in time. The world model 430 may transmit, to the path selector 450, the predicted next state along with the next action of each of the other vehicles.

The path selector 450 may receive the plurality of candidate paths available for the vehicle 100 to select and the next state corresponding to each candidate path. The path selector 450 may be a model that receives multiple next states predicted by the world model 430 and a reward value corresponding to each state and selects the most appropriate driving path. The path selector 450 may determine the driving path of the vehicle 100 based on the next state. For example, the path selector 450 may select the safest and most efficient driving path for the vehicle 100 to drive, based on the plurality of candidate paths generated by the path generator 410 and the next state predicted by the world model 430. The path selector 450 may select the most appropriate driving path through machine learning. For example, the path selector 450 may select the most appropriate path among the plurality of candidate paths generated by the path generator 410 by being trained through reinforcement learning. In an example, the learning objective of the path selector 450 may be as shown in Equation 2 below.

$$ϕ ( {s}_{t} , goal ) = {a}_{t , 1} , ⋯ {a}_{t , n} \qquad Equation 2$$

$$ω ( {s}_{0} , {a}_{t , i} ) = {s}_{t + 1 , i} , {r}_{t + 1 , i}$$

$$θ = ( {s}_{t + 1 , 1 : i} , {r}_{t + 1 , 1 : i} ) = {a}_{t + 1 , i}$$

Here φ, may represent the path generator 410, ω may represent the world model 430, θ may represent the path selector 450, t=0,1, . . . may represent the point in time until the vehicle 100 reaches s₀ may represent the surrounding situation of the vehicle 100 at the current point in time, aᵢ may represent the generated candidate paths, and rᵢ may represent a reward value.

FIG. 5 illustrates an example world model according to one or more embodiments.

Referring to FIG. 5, in a non-limiting example, a world model 500 (e.g., the world model 330 of FIG. 3 and the world model 430 of FIG. 4) may include a local encoder 510, a global encoder 520, and a global-local interaction processing element 530. The world model 500 may receive data (e.g., L₀) obtained by sensing a lane located around an ego-vehicle (e.g., the vehicle 100 of FIG. 1) and data (e.g., A₀ . . . Aₙ_{ᵢ}, obtained by sensing driving information on each of a plurality of other vehicles located around the vehicle 100. The sensing data (e.g., L₀ . . . Lₘ_{ᵢ} and A₀ . . . Aₙ_{ᵢ}) may be data (e.g., a bounding box and coordinates, velocity, and acceleration of a surrounding object) obtained when a sensor (e.g., the sensor 170 of FIG. 1) of the vehicle 100 senses the surroundings of the vehicle 100 and converts the sensed surroundings into a form that is suitable to be processed in the world model 500. The data A₀ . . . Aₙ_{ᵢ}, which is obtained by sensing driving information on each of the plurality of other vehicles, may include data obtained by sensing information on driving history (e.g., a driving trajectory), velocity, acceleration, direction, and location of each of the plurality of other vehicles. The input data of the world model 500 may not be sensing data from a single point in time but rather time-series sensing data. For example, the data L₀ . . . Lₘ_{ᵢ}, which is obtained when the sensor 170 senses a lane, may be time-series sensing data with different points in time for the same lane. The world model 500 may further receive data a_{E} about the ego-vehicle (e.g., the vehicle 100). The data a_{E} about the vehicle 100 may include driving-related information such as steering, velocity, and acceleration of the vehicle 100. The data a_{E} may be converted into a form of data

$$( e . g . , {A}_{0}^{+} )$$

suitable to be processed in the world model 500.

The data L₀ . . . Lₘ_{ᵢ}, which is obtained by sensing a lane, and the data A₀ . . . Aₙ_{ᵢ}, which is obtained by sensing driving information on each of the plurality of other vehicles, may each be input to a corresponding gated recurrent unit (GRU) (e.g., an L-GRU and an A-GRU). Each piece of sensing data may pass through the GRU and be output as data (e.g.,

$${L}_{0}^{′} ⋯ {L}_{{m}_{i}}^{′} and {A}_{0}^{′} ⋯ {A}_{{n}_{i}}^{′} )$$

in the form of a vector representing a hidden state. The data

$${A}_{0}^{+}$$

about the ego-vehicle (e.g., the vehicle 100) may be input to the A-GRU along with the sensing data for the plurality of other vehicles and be converted into data

$${A}_{0}^{′ +}$$

in the form of a vector.

The world model 500 may predict the next action of each of the plurality of other vehicles based on the data obtained by sensing a lane (e.g., lane data) and data obtained by sensing driving information on each of the plurality of other vehicles (e.g., driving data). The world model 500 may obtain an interaction (e.g., cross attention) result between the data obtained by sensing a lane and the driving information on each of the plurality of other vehicles. Based on the interaction result between the data obtained by sensing a lane and the driving information on each of the plurality of other vehicles, the world model 500 may predict the next action of each of the plurality of other vehicles. The interaction result between the data obtained by sensing a lane and the driving information on each of the plurality of other vehicles may be obtained using a cross-attention processing element 511 and a cross-attention processing element 513.

The cross-attention processing element 511 may output a latent vector sequence obtained by reflecting relationships with the plurality of other vehicles to a lane. The cross-attention processing element 511 may use vector-form data

$${L}_{0}^{′} ⋯ {L}_{{m}_{i}}^{′}$$

for a lane as a query Q and vector-form data

$${A}_{0}^{′} ⋯ {A}_{{n}_{i}}^{′}$$

for the plurality of other vehicles as a key K and a value V to output a latent vector sequence

$${L}_{0}^{*} ⋯ {L}_{{m}_{i}}^{*}$$

for the lane that reflects the and a value V to output a latent vector sequence relationships with the plurality of other vehicles. The cross-attention processing element 513 may output a latent vector sequence obtained by reflecting the relationships with the lane to data on the plurality of other vehicles. The cross-attention processing element 513 may use the vector-form data

$${A}_{0}^{′} ⋯ {A}_{{n}_{i}}^{′}$$

on the plurality of other vehicles as the query Q and the vector-form data

$${L}_{0}^{′} ⋯ {L}_{{m}_{i}}^{′}$$

on the lane as the key K and the value V to output a latent vector sequence

$${A}_{0}^{*} … {A}_{{n}_{i}}^{*} ,$$

for the plurality of other vehicles that reflects the relationships with the lane.

The latent vector sequence

$${A}_{0}^{*} … {A}_{{n}_{i}}^{*} ,$$

which reflects the relationships of the plurality of other vehicles with the lane, may be input as the query Q to a cross-attention processing element 515. The cross-attention processing element 515 may use the vector-form data

$${A}_{0}^{′ +}$$

on the ego-vehicle (e.g., the vehicle 100) as the key K and the value V and may output a latent vector sequence

$${A}_{0}^{\#} … {A}_{{n}_{i}}^{\#}$$

for the plurality of other vehicles that reflects the relationships with the ego-vehicle (e.g., the vehicle 100).

The next state of the ego-vehicle (e.g., the vehicle 100) predicted by the world model 500 may be obtained based on the result of performing cross attention between the plurality of candidate paths available for the vehicle 100 to select and the next action of each of the plurality of other vehicles located around the vehicle 100. For example, the world model 500 may use the cross-attention processing element 515 to obtain a next state 540 of the vehicle 100 based on the result of performing cross attention between data

$$( e . g . , {A}_{0}^{′ +} )$$

on the current state of the vehicle 100 and the latent vector sequence

$${A}_{0}^{*} … {A}_{{n}_{i}}^{*} ,$$

for the plurality of other vehicles, which reflects the relationships with a lane.

The latent vector sequence

$${A}_{0}^{\#} … {A}_{{n}_{i}}^{\#}$$

for the plurality of other vehicles reflecting the relationships with the ego-vehicle (e.g., the vehicle 100) may be input to the global encoder 520 along with the latent vector sequence

$${A}_{0}^{*} … {A}_{{n}_{i}}^{*} ,$$

for the plurality of other vehicles reflecting the relationships with a lane and the latent vector sequence

$${L}_{0}^{*} … {L}_{{m}_{i}}^{*}$$

for a lane reflecting the relationships with the plurality of other vehicles.

The global encoder 520 may perform multi-head attention on the input data to analyze a global pattern and each data relationship for the input data. The global encoder 520 may output a vector sequence G_{0:k} in which data on the ego-vehicle (e.g., the vehicle 100), the plurality of other vehicles, and a lane is globally compressed.

The vector sequence G_{0:k} may be input to the global-local interaction processing element 530 along with the latent vector sequence

$${L}_{0}^{*} … {L}_{{m}_{i}}^{*}$$

for a lane, which reflects the relationships with the plurality of other vehicles. The global-local interaction processing element 530 may include a lane selection processing element 535 and a cross-attention processing element 537. The lane selection processing element 535 may analyze information on lanes surrounding the vehicle 100 and select the top k lanes with the highest drivability of the vehicle 100.

The lane selection processing element 535 may use the vector sequence G_{0:k} to predict the top k lanes in which the vehicle 100 is likely to drive. The lane selection processing element 535 may calculate an attention score for each lane and select the top k lanes TopₖLᵢ based on the attention score. The lane selection processing element 535 may receive the latent vector sequence

$${L}_{0}^{*} … {L}_{{m}_{i}}^{*}$$

for a lane, which reflects the relationships with the plurality of other vehicles, as the query Q and the vector sequence G_{0:k}, which is the output of the global encoder 520, as the key K and the value V. The lane selection processing element 535 may output the top k lanes TopₖLᵢ in which the vehicle 100 is most likely to drive. TopₖLᵢ may be input to the cross-attention processing element 537 as the key K and the value V. The vector sequence G_{0:k}, which is the output of the global encoder 520, may be input to the cross-attention processing element 537 as the query Q. The cross-attention processing element 537 may ultimately output a vector sequence

$${G}_{0 : k}^{*} ,$$

which represents a global feature that reflects the relationships between lanes, the vehicle 100, and the plurality of other vehicles. The vector sequence

$${G}_{0 : k}^{*}$$

may be a vector sequence that reflects the relationships between the vehicle 100 and the plurality of other vehicles for the top k most likely lanes. By optionally performing cross attention on the lanes in which the vehicle 100 is most likely to drive, rather than considering all lanes around the vehicle 100, the world model 500 may efficiently combine a local feature with a global feature (e.g., G_{0:k}) to ensure that the vector sequence

$${G}_{0 : k}^{*}$$

precisely serves as a global context.

Based on a vector sequence

$${F}_{0 : k}^{C}$$

and the vector sequence

$${G}_{0 : k}^{*}$$

representing a local feature including the latent vector sequence

$${A}_{0}^{\#} … {A}_{{n}_{i}}^{\#}$$

for the plurality of other vehicles, which reflects the relationship with the ego-vehicle (e.g., the vehicle 100) and the latent vector sequence

$${L}_{0}^{*} … {L}_{{m}_{i}}^{*}$$

for a lane, which reflects the relationships with the plurality of other vehicles, the world model 500 may predict the next state (e.g., the next state 540) of the vehicle 100. The vector sequence

$${F}_{0 : k}^{C}$$

may be concatenated with the vector sequence

$${G}_{0 : k}^{*}$$

and may be used to predict the next state of the vehicle 100. The next state 540 of the vehicle 100 may include the predicted location (e.g., a predicted trajectory 541) of the vehicle 100 after the vehicle 100 drives for a predetermined time along each of the plurality of candidate paths and the positions of the plurality of other vehicles after the predetermined time elapses. The predicted trajectory 541 may include the predicted driving path and predicted location of the vehicle 100 for each of the plurality of candidate paths available for the vehicle 100 to select. The next state 540 may include a probability value (e.g., a probability value 543) assigned based on the likelihood of the vehicle 100 driving in each of the plurality of candidate paths. The driving likelihood may be calculated based on at least one of a loss function related to the distance between the vehicle 100 and the plurality of other vehicles (e.g., a distance loss function) and a loss function related to the vehicle 100 departing from the road (e.g., a departure loss function). In an example, the loss function related to the distance between the vehicle 100 and the plurality of other vehicles may be calculated by Equation 3 below.

$$loss = {\sum }_{i , j} {( {pred}_{i , j} - g {t}_{i , j} )}^{2} \qquad Equation 3$$

Here, i may denote an index for a predicted trajectory, and j may denote an index for the plurality of other vehicles.

The loss function related to the vehicle 100 departing from the road may be calculated by Equation 4 below.

$$loss = {\sum }_{i} {( {gen}_{i} - g {t}_{i} )}^{2} \qquad Equation 4$$

In an example, equation 4 may be an equation that calculates a loss based on the Euclidean distance, ensuring that the generated driving path of the vehicle 100 is similar to the actual driving path.

The next state 540, which is the output of the world model 500, may be transmitted to a path selector (e.g., the path selector 450 of FIG. 4). The actual driving data (GT) may include only normal data in which the vehicle 100 does not depart from the road or collide with an obstacle. The world model 500 may assign the probability value 543 based on a loss value, which is the difference between the actual data and the predicted data (e.g., the predicted trajectory 541) and use the probability value 543 as a reward to perform reinforcement learning, thereby generating a safer path.

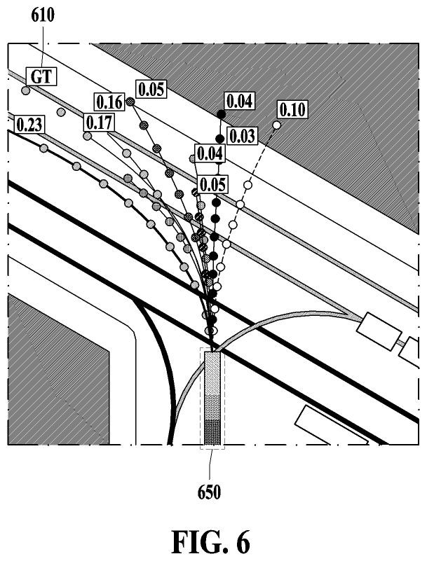

FIG. 6 illustrates an example predicted trajectory according to one or more embodiments.

Referring to FIG. 6, in a non-limiting example, a next state (e.g., the next state 540 of FIG. 5) of an ego-vehicle 650 (e.g., the vehicle 100 of FIG. 1) may be predicted by a world model (e.g., the world model 500 of FIG. 5). The next state may include a probability value assigned based on the driving likelihood for each of a plurality of candidate paths available for the ego-vehicle 650 to select. The probability value may be a value assigned to a predicted trajectory corresponding to each path candidate. For example, the numbers shown at the end of each path (e.g., 0.10) may represent the predicted likelihood of the ego-vehicle 650 driving along that path. The driving likelihood may be calculated based on at least one of a loss function related to the distance between the ego-vehicle 650 and the plurality of other vehicles and a loss function related to the roadway departure of the ego-vehicle 650. For example, the driving likelihood may be assigned based on the loss value calculated in relation to actual driving data (GT) 610. A path selector (e.g., the path selector 450 of FIG. 4) may determine, as the driving path of the ego-vehicle 650, the path with the highest probability value. For example, the path with the highest probability value of 0.23 may be determined as the driving path of the ego-vehicle 650. The path with the highest probability value may be a path most similar to the actual driving data (GT). A path generating device (e.g., the path generating device 200 of FIG. 2) may transmit the determined driving path of the ego-vehicle 650 to a vehicle controller (e.g., the vehicle controller 230 of FIG. 2).

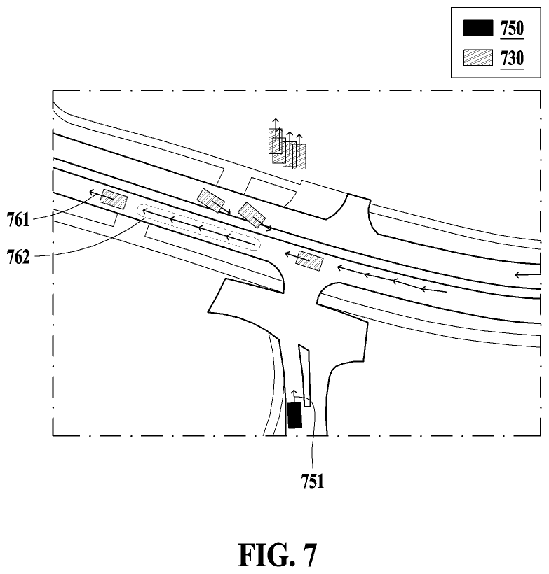

FIG. 7 illustrates an example predicted next state according to one or more embodiments.

Referring to FIG. 7, in a non-limiting example, an example of a next state output by a trained world model (e.g., the world model 500 of FIG. 5) is illustrated. The world model 500 may predict the next states of an ego-vehicle 750 (e.g., the vehicle 100 of FIG. 1) and a plurality of other vehicles (e.g., other vehicles 730). A driving trajectory 762 may represent the driving history (e.g., a driving trajectory) of the other vehicles. The arrows (e.g., an arrow 751 and an arrow 761) connected to the ego-vehicle 750 and the other vehicles 730 may indicate the driving direction of each vehicle.

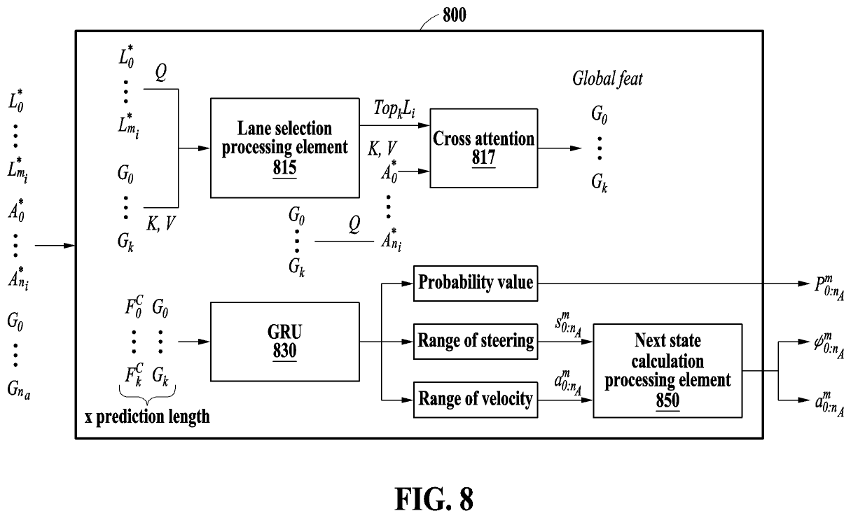

FIG. 8 illustrates an example decoder according to one or more embodiments.

Referring to FIG. 8, in a non-limiting example, a decoder 800 may be located inside a world model (e.g., the world model 500 of FIG. 5) or be a separate external processing element. The decoder 800 may simulate a next state (e.g., the next state 540 of FIG. 5) predicted by the world model 500 to generate virtual driving data. The generated virtual driving data may be used for reinforcement learning of the world model 500.

The decoder 800 may generate the vector sequence

$${G}_{0 : k}^{*}$$

representing global features for the top k lanes using a lane selection processing element 815 and a cross-attention processing element 817. The lane selection processing element 815 and the cross-attention processing element 817 may be similar to the lane selection processing element 535 and the cross-attention processing element 537, respectively, described above with reference to FIG. 5.

In an example, the decoder 800 may predict the next state of the vehicle 100 based on the vector sequence

$${F}_{0 : k}^{C}$$

and the vector sequence

$${G}_{0 : k}^{*}$$

representing local features. The vector sequence

$${F}_{0 : k}^{C}$$

may be concatenated with the vector sequence

$${G}_{0 : k}^{*} ,$$

input to a Gated Recurrent Unit (GRU) 830, and then processed through a linear layer. The linear layer may include a linear layer related to the steering and velocity of the vehicle 100 and a linear layer related to a probability value. The outputs of the linear layers for steering and velocity, denoted as

$${S}_{0 : {n}_{A}}^{m} and {a}_{0 : {n}_{A}}^{m} ,$$

respectively, may be input to a next state calculation processing element 850 and output as the next location of the vehicle 100 while considering physical constraints. For example, the next state calculation processing element 850 may apply a hyperbolic tangent (tanh) activation function to

$${S}_{0 : {n}_{A}}^{m} and {a}_{0 : {n}_{A}}^{m} ,$$

scaling

$${S}_{0 : {n}_{A}}^{m} and {a}_{0 : {n}_{A}}^{m}$$

to predefined limit values. The output of the decoder 800 may be used for the reinforcement learning of the world model 500.

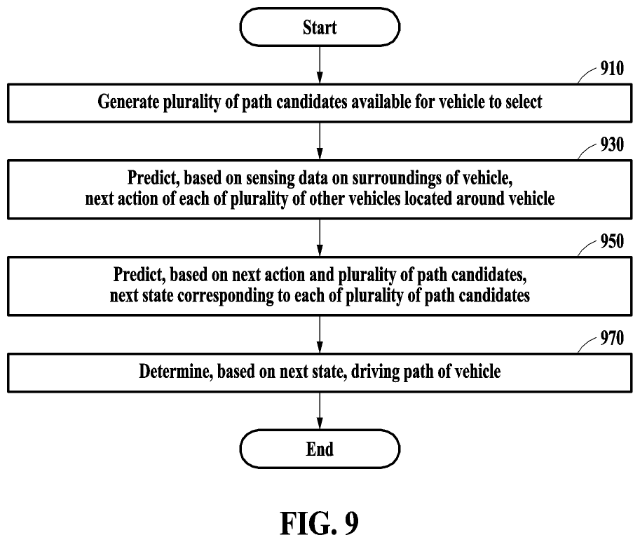

FIG. 9 illustrates an example method of generating a path according to one or more embodiments.

Referring to FIG. 9, in a non-limiting example, operations 910 to 970 may be similar to the operations performed by the path generating device (e.g., the path generating device 200 of FIG. 2 and the path generating device 300 of FIG. 3) described with reference to FIGS. 1 to 8 and thus, repeated descriptions thereof are omitted.

Operations 910 to 970 may be understood as being performed by a processor of the path generating device 200 (e.g., the processor 1030 of FIG. 10).

In an example in operation 910, the path generating device 200 may generate a plurality of candidate paths available for a vehicle (e.g., the vehicle 100 of FIG. 1) to select. The plurality of candidate paths may be generated based on an available range of steering and an available range of velocity of the vehicle 100. Operation 910 may be similar to the operation of the path generator 410 described above with reference to FIG. 4.

In an example in operation 930, the path generating device 200 may predict the next action of each of the plurality of other vehicles located around the vehicle 100 based on sensing data on the surroundings of the vehicle 100. The path generating device 200 may predict the next action of each of the plurality of other vehicles based on the interaction result between data obtained by sensing a lane and driving information of each of the plurality of other vehicles located around the vehicle 100.

In an example in operation 950, the path generating device 200 may predict a next state corresponding to each of the plurality of candidate paths, based on the next action and the plurality of candidate paths. The next state may include the predicted location of the vehicle 100 after the vehicle 100 drives for a predetermined time along each of the plurality of candidate paths and the locations of the plurality of other vehicles after the predetermined time elapses. Operation 950 may be similar to the operations performed by the world model (e.g., the world model 330 of FIG. 3) described above with reference to FIGS. 3 to 6.

In an example in operation 970, the path generating device 200 may determine the driving path of the vehicle 100 based on the next state. Considering the next state predicted by the world model (e.g., the world model 330 of FIG. 3), the path generating device 200 may determine, as the driving path, the safest and most efficient path available for the vehicle 100 to select.

Operations 910 to 970 may be performed sequentially, but examples are not limited thereto. For example, two or more operations may be performed in parallel.

FIG. 10 illustrates an example electronic apparatus according to one or more embodiments.

Referring to FIG. 10, in a non-limiting example, an electronic apparatus 1000 (e.g., the path generating device 200 of FIG. 2) may be an apparatus for generating a driving path of an AD vehicle (e.g., the vehicle 100 of FIG. 1). The electronic apparatus 1000 may include a memory 1010 and the processor 1030. The electronic apparatus 1000 may be implemented as devices such as a communication device such as a smartphone, a vehicle such as a car, a display device such as a TV, a consumer electronic apparatus such as a washing machine, and an apparatus such as a manufacturing apparatus.

The memory 1010 may include computer-readable instructions. The processor 1030 may be configured to execute computer-readable instructions, such as those stored in the memory 1010, and through execution of the computer-readable instructions, the processor 1030 is configured to perform one or more, or any combination, of the operations and/or methods described herein. The memory 1010 may be a volatile or nonvolatile memory.

The processor 1030 may further execute programs, and/or may control other operations or functions of the electronic device 1000 and operations of a vehicle (e.g., vehicle 100), and may include any one or a combination of two or more of, for example, a central processing unit (CPU), a graphic processing unit (GPU), a neural processing unit (NPU) and tensor processing units (TPUs), but is not limited to the above-described examples.

The memory 1010 may store instructions for the operation of generating a plurality of candidate paths available for a vehicle to select, an operation of predicting the next action of each of a plurality of other vehicles located around the vehicle based on sensing data on the surroundings of the vehicle, an operation of predicting a next state corresponding to each of the plurality of candidate paths based on the next action and the plurality of candidate paths, and an operation of determining the driving path of the vehicle based on the next state. However, this is only an example, and the information stored in the memory 1010 is not limited thereto.

The processor 1030 may be a data processing device implemented by hardware including a circuit having a physical structure to execute desired operations. For example, the desired operations may include code or instructions in a program.

For example, the data processing device implemented by hardware may include a microprocessor, a central processing unit (CPU), a processor core, a multi-core processor, a multiprocessor, an application-specific integrated circuit (ASIC), or a field programmable gate array (FPGA).

By executing the code and/or instructions stored in the memory 1010, the processor 1030 may enable the electronic apparatus 1000 to perform one or more operations. The operations performed by the electronic apparatus 1000 may be similar to the operations performed by the path generating device 200 described with reference to FIGS. 1 to 10 and thus, repeated descriptions thereof are omitted.

The electronic apparatuses, vehicles, neural networks, processors, memories, system 10, vehicle 100, AD device 105, memory 110, processor 130, server 150, communication interface 190, path generating device 200, vehicle controller 230, sensor 270, path generating device 300, path generator 310, world model 330, path selector 350, path generator 410, world model 430, path selector 450, world model 500, cross-attention processing element 511, cross-attention processing element 513, global encoder 520, global-local interaction processing element 530, lane selection processing element 535, decoder 800, lane selection module 815, next state calculation module 850, cross attention processing element 817, GRU 830, electronic apparatus 1000, memory 1010, and processor 1030 described herein and disclosed herein described with respect to FIGS. 1-10 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROM, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating a plurality of candidate paths available for a vehicle to select;
predicting, based on sensing data on surroundings of the vehicle, a next action of each of a plurality of other vehicles located around the vehicle;
predicting, based on the next action and the plurality of candidate paths, a next state corresponding to each of the plurality of candidate paths; and
determining, based on the next state, a driving path of the vehicle.

2. The method of claim 1, wherein the sensing data comprises lane data obtained by sensing a lane located around the vehicle and driving data obtained by sensing driving information for each of the plurality of other vehicles.

3. The method of claim 2, wherein the predicting of the next action comprises:
obtaining an interaction result between the lane data and the driving data for each of the plurality of other vehicles; and
predicting, based on the interaction result, the next action of each of the plurality of other vehicles.

4. The method of claim 2, wherein the driving data for each of the plurality of other vehicles comprises information on a driving history, a velocity, an acceleration, a direction, and a location of each of the plurality of other vehicles.

5. The method of claim 1, wherein the plurality of candidate paths is generated based on an available range of steering and an available range of velocity of the vehicle.

6. The method of claim 1, wherein the next state comprises a probability value assigned based on a likelihood of the vehicle driving in each of the plurality of candidate paths.

7. The method of claim 6, wherein the likelihood of the vehicle driving in each of the plurality of candidate paths is calculated based on one or more of a distance loss function related to a distance between the vehicle and the plurality of other vehicles and a departure loss function related to roadway departure of the vehicle.

8. The method of claim 1, wherein the next state is obtained based on a result of performing cross attention between the plurality of candidate paths and the next action of each of the plurality of other vehicles.

9. The method of claim 6, wherein the next state comprises:
a predicted location of the vehicle after the vehicle drives for a predetermined time along each of the plurality of candidate paths; and
respective locations of each of the plurality of other vehicles after the predetermined time elapses.

10. A non-transitory computer-readable storage medium storing instructions that, when executed by a processor, cause the processor to perform the method of claim 1.

11. An electronic apparatus, comprising:
processors configured to execute instructions; and
a memory storing the instructions, wherein execution of the instructions configures the processors to:
generate a plurality of candidate paths available for a vehicle to select;
predict, based on sensing data on surroundings of the vehicle, a next action of each of a plurality of other vehicles located around the vehicle;
predict, based on the next action and the plurality of candidate paths, a next state corresponding to each of the plurality of candidate paths; and
determine, based on the next state, a driving path of the vehicle.

12. The apparatus of claim 11, wherein the sensing data comprises lane data obtained by sensing a lane located around the vehicle and driving data obtained by sensing driving information for each of the plurality of other vehicles.

13. The apparatus of claim 12, wherein the predicting of the next action comprises:
obtaining an interaction result between the lane data and the driving data for each of the plurality of other vehicles; and
predicting, based on the interaction result, a next action of each of the plurality of other vehicles.

14. The apparatus of claim 12, wherein the driving data for each of the plurality of other vehicles comprises information on a driving history, a velocity, an acceleration, a direction, and a location of each of the plurality of other vehicles.

15. The apparatus of claim 11, wherein the plurality of candidate paths is generated based on an available range of steering and an available range of velocity of the vehicle.

16. The apparatus of claim 11, wherein the next state corresponding to each of the plurality of candidate paths comprises a probability value assigned based on a likelihood of the vehicle driving in each of the plurality of candidate paths.

17. The apparatus of claim 16, wherein the likelihood of the vehicle driving in each of the plurality of candidate paths is calculated based on one or more of a distance loss function related to a distance between the vehicle and the plurality of other vehicles and a departure loss function related to roadway departure of the vehicle.

18. The apparatus of claim 11, wherein the next state is obtained based on a result of performing cross attention between the plurality of candidate paths and a next action of each of the plurality of other vehicles.

19. The apparatus of claim 16, wherein the next state comprises:
a predicted location of the vehicle after the vehicle drives for a predetermined time along each of the plurality of candidate paths; and
respective locations of each of the plurality of other vehicles after the predetermined time elapses.
